(19) United States
(12) Patent Application Publication
(10) Pub. No.: US 2010/0058760 A1
(43) Pub. Date: Mar. 11, 2010

(54) METHOD AND DEVICE FOR GENERATING MECHANICAL ENERGY

(76) Inventor: Felix Wirz, Lutzenberg (CH)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 12/532,449

(22) PCT Filed: Mar. 25, 2008
(86) PCT No.: PCT/CH2008/000125

§ 371 Date: Nov. 10, 2009

(30) Foreign Application Priority Data
Mar. 22, 2007 (CH) 462/07

(51) Int. Cl. F03G 6/00; F01K 25/08; F02F 1/40

(52) U.S. Cl. 60/641.8; 60/651; 123/41.82 R

(57) ABSTRACT

The invention relates to a method for generating mechanical energy, characterised by a gas or a liquid which drives an expansion machine designed therefor even at a low pressure, i.e. economically.

The present invention relates to a method for generating mechanical energy from thermal energy, as well as to a device for carrying out this method, and to a further device permitting the utilization of flow energy of water or wind—upwind power stations—, even at low velocity or pressure, by means of the Wankel engine described in more detail in this patent.

Thermal energy or potential energy can be converted into mechanical energy both by heating as well as by cooling a gaseous operating medium by means of compressed air or a pressurized liquid substance.

Methods and devices of this type are already known. These have been described, for instance, in WO 2006/027438 and FR2317523. The subject of these publications suffers from the substantial drawback that the energy carrier needs to be heated to such a high temperature and must at the same time be available in such high quantity so as to thereby allow a turbo machine such as, for example, a turbine, to be driven.

It is the object of the present invention to overcome this as well as other disadvantages of the state of the art.

According to the invention, this object is attained by the method of the genus set out in the opening paragraph, as defined in the characterizing portion of patent claim 1.

According to the invention, this object is further attained by a device for carrying out the method of the genus set out in the opening paragraph, as defined in the characterizing portion of patent claim 6 or 7.

In what follows, embodiments of the present invention are elucidated in detail by way of the accompanying drawings. There is shown in:

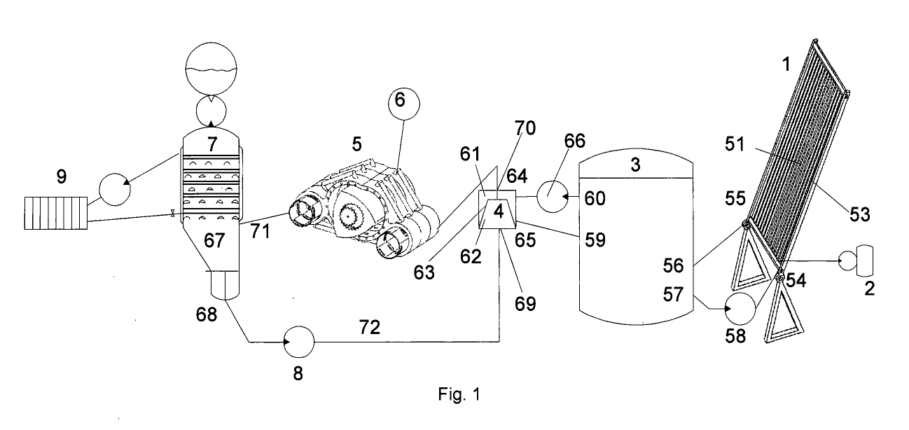

FIG. 1, schematically, the present device as a cyclic process, driven by solar collectors,

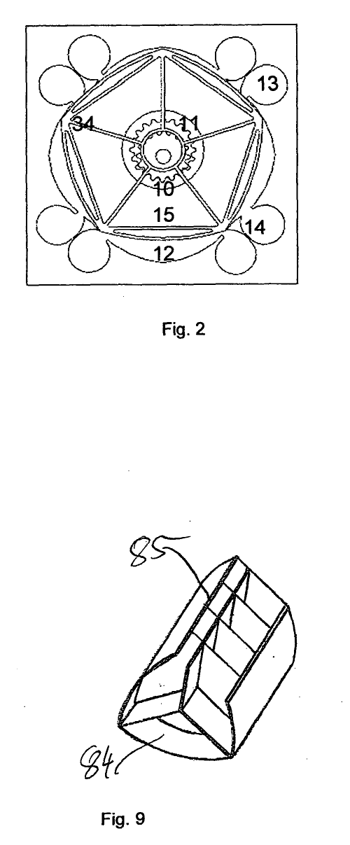

FIG. 2, the geometry, in cross-section, of a Wankel engine,

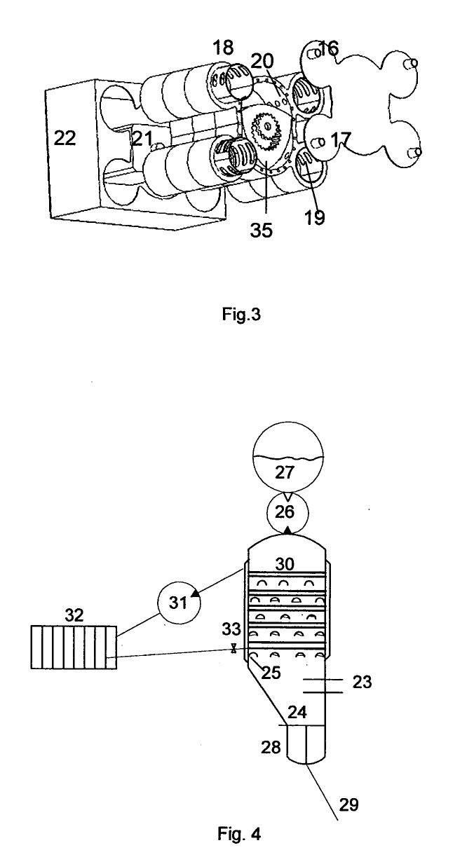

FIG. 3, the geometry, schematically, of a Wankel engine with a rotary valve control,

FIG. 4, schematically, a condenser for the fluid used in the present device,

FIG. 5, a circuit diagram of the present device which is so designed that the cooling region can be cooled by the natural temperature drop occurring between day and night,

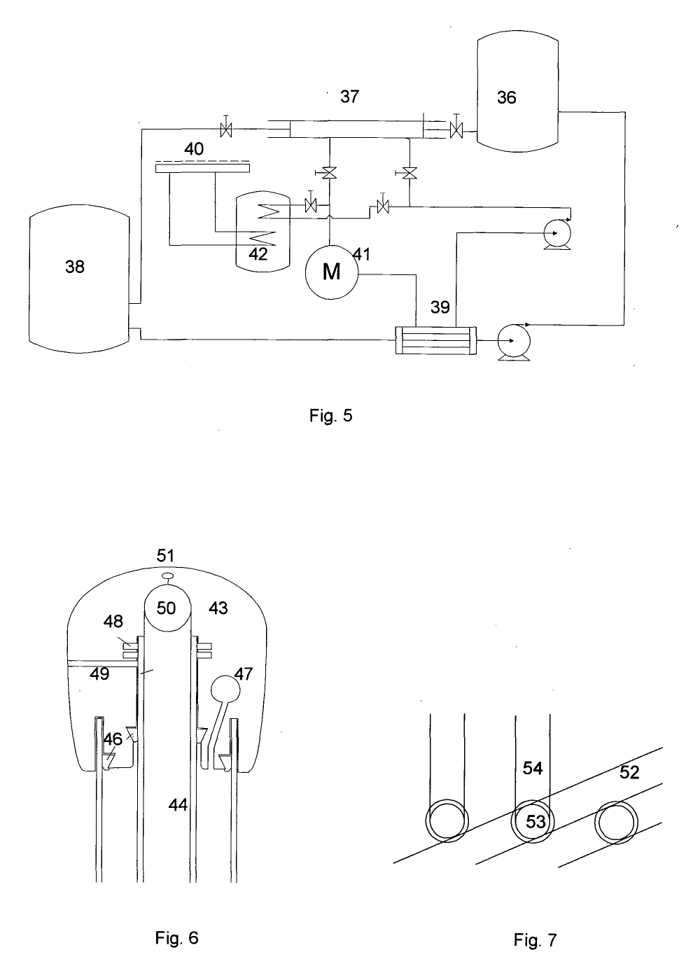

FIG. 6, schematically, a cross-section through a support bar and vacuum tube of the solar collector,

FIG. 7, in a perspective view, a section of an arrangement of vacuum tubes of the solar collector,

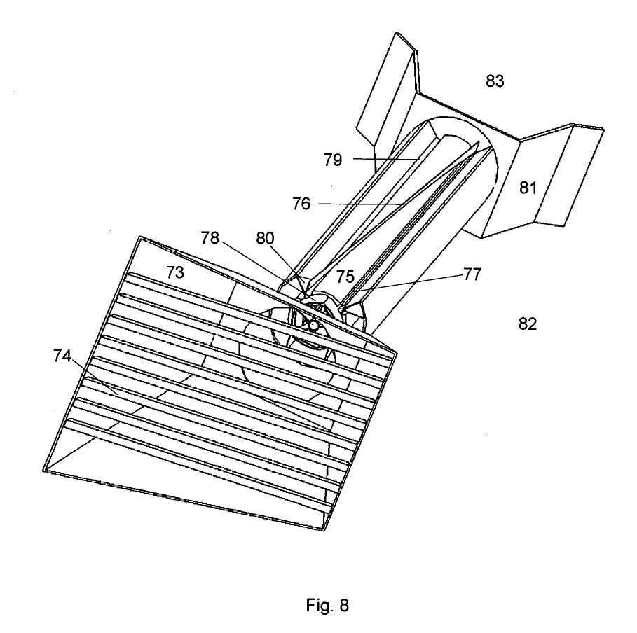

FIG. 8, schematically, an application as a non-cyclic process as a river power station by way of a sectional view through the engine housing and

FIG. 9, schematically, a sheet metal construction of a rotary piston.

FIG. 1 schematically shows a device for carrying out the present method. This device comprises heat exchangers or panels 9, known per se, including solar cells as well as a collector 1 for sunlight, comprising vacuum tubes 53 arranged parallel to one another. The collector 1 and the panels 9 may be set up on the ground. The spaced-apart relationship between the tubes 51 of the collector 1 is so selected that the ground underneath can be radiated by the sun as well as supplied with rainwater. In addition, the device comprises a vacuum pump 2 which is connected to the collector tubes 53 in order to bring about and maintain an insulating vacuum in the collector tubes 45. The vacuum tubes 53 are connected in series so that such a set of vacuum tubes 53 comprises an inlet connector 54 and an outlet connector 55. A fluid, capable of absorbing thermal energy, can flow through such a set of vacuum tubes 53. In the simplest case this fluid is water.

The device further includes a heat-insulated container 3, in which the fluid can be stored temporarily, preferably without thermal loss. This container 3 includes a first inlet connector 56 and a first outlet connector 57. The outlet connector 55 of the collector 1 is connected to the inlet connector 56 of the container 3. The outlet connector 57 of the container 3 is connected to the inlet connector 54 of the collector 1. In the so formed first cycle of the present device the fluid is able to circulate. This circulation is supported by a first pump 58, which, in the case illustrated, is interposed in the outlet line leading out of the container 3. During circulation, the thermal energy, recovered by the fluid in the collector 1, is transferred to the fluid in the container 3. In this manner, the thermal energy recovered in the solar collector 1 can be stored in the container 3.

The present device also includes an evaporator unit 4. This evaporator unit 4 is so designed, in a manner known per se, that a material can be evaporated therein under the effect of heat. This evaporator unit 4 may be designed like a heat exchanger, wherein two cavities 61 and 62 are present. Between these cavities 61 and 62 a wall 63 is present, through which heat may be transferred from the first cavity 61 to the second cavity 62, with as little loss as possible.

The container 3 includes a second inlet connector 59 and a second outlet connector 60. The evaporator unit 4 comprises a first inlet connector 64 and a first outlet connector 65, these connectors 64 and 65 ending in the first cavity 61. The outlet connector 60 of the container 3 is connected to the first inlet connector 64 of the evaporator unit 4. The outlet connector 65 of the evaporator unit 4 is connected to the first inlet connector 59 of the container 3. In the so formed second cycle, the fluid is able to circulate. This circulation is supported by a second pump 66 which, in the case illustrated, is interposed in the second outlet line leading out of the container 3. During circulation in this second cycle, the fluid passes from the container 3 into the first cavity 61 of the evaporator unit 4. The same fluid may circulate both through the first and the second cycle.

The device further includes a condenser 7 known per se, which may be complemented by a cooling aggregate 9, likewise known per se. The condenser 7 includes an inlet connector 67 and an outlet connector 68. The second cavity 62 in the evaporator unit 4 is equipped with an inlet connector 69 and an outlet connector 70. The outlet connector 70 of the second cavity 62 is connected to the inlet connector 67 of the condenser 7 by means of a first connection line 71. The outlet connector 68 of the condenser 7 is connected to the inlet connector 69 of the second cavity 62 via a second connection line 72. In this second connection line 72 a circulating pump 8 is interposed. In the first connection line 71, an aggregate is interposed, consisting of an engine 5 and a generator 6 coupled to the said engine 5 and able to generate electricity. A material may circulate in this cycle which in the second cavity 62 of the evaporator unit 4 may be evaporated due to the thermal energy supplied by the container 3.

Downstream of the engine 5, in the condenser unit 7, the gas is cooled down or compressed or both at the same time, in order to liquefy it. By way of the pump 8, the said liquid re-enters the second cavity 62 of the evaporator 4. The cooling unit 7 may be additionally cooled with the aid of the cooling aggregate 9.

The engine 5 may appropriately be a Wankel engine. FIG. 2 schematically shows a cross-section through the geometry of a Wankel engine without valve control. This geometry has the ratio 4/5 of the gearwheel 10 to the inner gear rim 11 with a corresponding geometry of a pentagon, revolving in a rounded-off quadrangle, thus forming chambers 12 for the expansion. If the piston is to revolve clockwise, the pressurized gas or medium flows into the chamber through the first aperture 13, leaving the latter through the second aperture 14. Sufficiently large feed ducts ensure a good supply of the chambers of the engine 5 with the gas, without excessive pressure drops. This design of the engine 5 may be manufactured in a filiform manner with webs 15 or made from sheet metal, permitting a lightweight rigid design of the rotor. The triangular geometry for stiffening and forming the curves, which may be interconnected to form a nodal junction 34, proves advantageous in order to withstand the pressures.

FIG. 3 schematically shows the configuration of a 2/3 Wankel engine having a rotary valve control. Through inlet ducts, apertures 16 and outlet apertures 17, the gas or medium is fed to the engine 5 and moved away from the latter. A roll 18 synchronized with the shaft of the engine 5 revolves in a housing ensuring a sealing relationship. Through apertures 19, slots in the roll which, through the rotary motion, align with apertures 20 in the engine housing, the medium flows into the engine 5 and after pressure release back again into the outlet rolls. The generator 21 converts the rotary motion into electricity. The entire engine 5 may be sealed off by means of a housing 22. The rotary piston is not manufactured—as is normally the case—in the form of a disk, but in the form of an elongated drum—a cylinder 35—, which is able to transmit high forces to the shaft despite the low pressure.

FIG. 4 schematically shows the condenser 7, in which the gas 23, flowing in from the engine 5, can be introduced into a liquid 24 and cooled. The medium, still in a gaseous state, gathers in small bubble caps 25, being receptacles closed towards the top and present throughout in the container, and is uniformly distributed. A pump 26 provides a large volume flow into the condenser unit 7 by conveying liquid or gas and air into a further receptacle 27. The same or another pump may be used for compressing the container-penetrating gas in order to thereby liquefy the gas. For this purpose, the inlet duct 23 should be in closed position and a further condensing unit should be set cyclically for suctioning off gas from the engine 5.

Cooling units, cooling bodies or cooling tubes 30 cool off the coolant liquid, transferring the heat to a cooling aggregate 32 by means of a pump 31. Alternatively, they are fed from a refrigeration accumulator. A valve 33 permits a complete discharge without mixing processes.

FIG. 5 schematically shows a circuit diagram for cooling down the cooling region through the natural temperature drop occurring between day and night. The fluid transferring the thermal energy, which accumulates during the day, is collected in the vessel 36 in order to permit its use during the night via an efficiently heat-radiating collector 37 in a further vessel 38 for renewed use in the condenser—the cooling unit 39—. During the day, the collector 37 may be used for heat absorption from solar energy, thereby assisting the higher-quality collectors 40 in their energy absorption. This is done either by mixing upstream of the evaporator unit and the engine 41, as shown, or by their feeding upstream into the higher quality collectors or pre-heating of the fluid reservoir 42.

FIG. 6 schematically shows a cross-section through a support bar 43 and vacuum tubes, including two separate tubes, an inner tube 44 for the heat fluid and the outer tube 45 made of glass, serving to delimit the vacuum. By means of seals 46, pressed-on additionally by the vacuum, the system is protected against losses. By way of a duct 47, the vacuum can be built up and then reduced again. Additional seals 48 may be provided preventing the leakage of fluid and for fixing the inner tube. The tubes, preferably a single tube, which proves advantageous for not creating stresses, may be fixed mechanically 49. The liquid enters into the next-following tube through an aperture 50. A venting duct 51 is advantageous.

FIG. 7 schematically shows an arrangement of vacuum tubes 53, mounted in spaced-apart relationship to one another and projecting, for example, into a support bar. Due to the oblique incidence 52, the light freely impacts the tubes for several hours per day with identical output and small areas of loss, for example at midday 54, when the sun is positioned at right angles. Moreover, the ground under the collector is impacted both by rain as well as by residual light, thereby making possible a double function of solar utilization and agriculture.

FIG. 8 schematically shows an application as a non-cyclic process, as a river power station by way of a sectional view through the engine housing above and at the front end, where the piston is. The volume flow towards the machine is increased by means of a sheet piling 73. A means comprising rungs 74 or grids deflects drift matter or rocks and stones in order to protect the machine. Through a duct 75, preferably tapered towards the rear by a web 76, the water flows radially onto the Wankel piston 78 through apertures, a slot 77, over the entire length thereof. Through a further slot 79, advantageously protected from inflowing water by a receptacle—the wall 80—closed towards the flow, the water exits the machine again. A further sheet piling 81, projecting into the flow, creates good outflow, even a gradient, in that the water 82 flowing past is accelerated through the constriction, flows rapidly past the device and, as a result, fills up the basin 83 behind the machine to a lesser extent.

FIG. 9 schematically shows a further variant of an elongated rotary piston 84 made of sheet metal, including webs 85.

It is an important advantage of the present invention that very low pressures in the fluid can be converted into kinetic energy. A further advantage is the fact that an engine depressurizes the driving medium into a closed space, transmitting the pressure to a shaft as mechanical energy. The material molecules, due to the impact and fling-back action from the side walls, hit the effective surface area of the engine several times. In the course thereof they transmit to the effective surface area of the engine more energy than would be the case if they, for example as in a turbine or turbo machine, were flung away after impacting the effective surface area thereof and were entrained by the flow flowing past.

The principle of the Wankel engine is particularly well suited as a design for such engines acting as an expansion machine or a pulsed turbo machine. Due to the very short crankshaft in relation to the piston area, a powerful, rapid rotary movement can be brought about even at a very low pressure. Besides the generally known ratio of 2/3 of the tooth formation of the gearwheel on the housing to the inner gear rim on the piston, designs which are even more rounded-off with lower ratios x/x+1 are particularly advantageous. In this case, a polygon turns inside a housing which has one longitudinal extension less than the polygon. At a ratio 2/3 of the classic Wankel, for example, this corresponds to a triangle in a rectangle as a line and at a ratio of 4/5 to a pentagon in a rectangle as a cross.

In an engine based on the Wankel engine, used as an expansion machine using a pressurized medium, instead of as an explosion machine, a plurality of piston areas may simultaneously be impinged by a force, pressure or reduced pressure, bringing about very high torque in a small oscillating mass. This is so, because virtually all around the pivoting axle forces and torques act in the direction of the rotary motion.

In the classic 2/3 configuration of the Wankel engine this means that in comparison to an internal combustion engine pressure is applied to the piston during the intake stroke, that during the compression cycle the piston is sucked by reduced pressure in the direction of rotation, that pressure again acts during the explosion cycle and that, in turn, a reduced pressure can be brought about during the exhaust-emission cycle. In the 3/4 design, 6 pulse ranges are available for the effect of force instead of the 4 as described above for the 2/3 Wankel. The smaller the ratio, the smoother is the running of the engine and the more pulse ranges are created, in each case twice as many as piston corners are generated.

The piston may be elongated along the axis, bringing about a very large effective surface area. Because of the property of turning a shaft at high efficiency at low pressure, various technologies may be used which to date had not been employed. Industrial waste heat or geothermal heat may already be converted into electricity at a very low temperature gradient by means of such heat-power-machine. The day-night temperature gradient is already sufficient in some instances to generate adequate pressure in suitable materials, e.g. freon or ether, for overcoming the run-up torque. Very simple collectors, for example sheet metal panels through which a liquid flows, may be used, in particular in order to form a large favorable cooling surface, if there is no natural possibility for cooling.

Water with its extraordinarily favorable specific thermal capacity may be employed within the temperature range of such machines in an environmentally-compatible and very cost-effective manner to serve as an energy storage means, heat accumulator. With appropriate insulation and dimensioning of the storage container, the energy can be stored for weeks with only minimal losses and can be retrieved according to requirements.

The evaporator unit may either be heated by a heat exchanger, flooded directly with the water or a further liquid may be heated in the storage tank by means of a heat exchanger in order to be able to mix it in the evaporator with the medium to be evaporated. By heating in a heat exchanger in the storage tank, the latter can be left unpressurized, and mixing of the poorly environmentally-compatible freon with the water can be prevented.

A further modification resides in that the operating medium is heated directly in the solar panel and is added to the process. On the one hand, simple sheet metal collectors through which a medium flows can be used, absorbing heat for the heating process during the day and releasing energy during the night so as to discharge heat from the coolant liquid accumulator to the environment. It is important to avoid pressures which are too high and which could cause bursting of the panels, or would render the construction too expensive. Due to the low temperature gradient, this technology, by means of very cost-effective solar panels, allows the production of solar energy.

In many places, in particular, those with an abundance of solar radiation, such as, for example, in the desert, no cooling water exists. If a coolant liquid accumulator is installed and the liquid, after use in the condenser, the cooling unit, is pumped into a second receptacle, the former can be cooled over night due to the usually high temperature gradient in deserts and be treated for renewed use.

The larger the surface area, the better is the cooling of a medium. For this reason, it is of interest to let the coolant liquid flow overnight through the same solar collectors, through which the heat medium was passed during the day. The advantage thereof is that the full temporal utilization of the solar cells is nearly twice as high as in photovoltaics, due to the day and night operation. Moreover, a more complicated technology for the cooling process can be dispensed with.

If large-scale plants are installed, a very cost-effective vacuum technology can be used to serve as a solar panel by employing direct-flow tubes instead of the conventional U-shapes with only one aperture. This does away with all high costs applicable to heat conversion currently known for small-scale installations. In that case, heat pipes or small copper pipes need to be used, which have to be passed into and out of each pipe. In order to avoid the formation of thermal stresses between the inner and outer pipes, these may be installed separately from one another and be protected against vacuum losses by means of seals involving metal cutting technology. The vacuum may be locked in permanently or may be built up by means of a pump in order to compensate for losses by leakage. Losses by leakage are thereby recognizable and also defrosting of the outer pipe becomes possible by reducing the vacuum and causing a through-flow by the heated liquid.

Evacuated flat collectors are likewise very suitable for collecting solar energy in an efficient manner. Other tube constructions without excessively high temperature stresses can be realized by means of ceramic glasses, by appropriately short tube sections or soft connections which are sealed.

An interesting double function of the heat accumulator is that—should sufficient power capacity exist—the warm, economically-charged energy storage means may be used for heating purposes, for example in adjacent buildings.

Particularly efficient temperature transfers are important in the case of a thermal engine. If materials are combined in an appropriately suitable fashion, this can be done efficiently by mixing fluids. If, for example, freon (R123) is injected into hot or cold oil, none of the two materials decompose up to about 200° Celsius. The freon which is twice as heavy in liquid form, can, after the cooling process, simply be withdrawn in the lower region of the cooling tank for further use.

If, in the course thereof, oil is taken in, this will return to the cooling tank after having passed through the process. Neither in the region of heating-up which may also take place in oil, nor in the engine which is actually lubricated thereby or might even intentionally be equipped with additional lubrication lines, would any material disadvantages arise from this. Various other material combinations or single-material operation are possible, depending on the field of use and temperature gradient or demands made on the installation.

Because of the relatively low pressure, the process can be optimized in that by the intake of gas into the coolant liquid the efficiency of the engine can be increased on the one hand, and in that, on the other, the gas, due to compression of the gas-liquid-mixture, is liquefied again at higher temperatures and can again be fed to the evaporation process.

The suction or compression process may take place either hydraulically or pneumatically by means of a pump as well as mechanically by a cylinder. The process is performed preferably pulsewise and, accordingly, in a plurality of cooling units. The gas flowing into the coolant liquid is reduced in volume by cooling, which, in turn, reduces the pumping-, suction power. If, in addition, the gas is prevented from rising, is separated and uniformly distributed in the cooling tank by means of small bubble caps—receptacles which are closed towards the top—, uniform heat emission and precipitation takes place by the subsequently increased pressure or further cooling.

The property of the Wankel engine of being able to set into motion a shaft at high power and a high number of revolutions, even at low pressure, may be used for electricity generation, which, to date, could not be attained by other engines or turbines.

Due to the geometry of the Wankel engine, further utilization of hydropower can be realized economically in that at the low pressure which at a low gradient and corresponding flow velocity no longer allows turbine technology, an engine and generator can be operated. The operations are limited to simple earth movements, edge fortifications and the assembly of the cost-effective engine technology which may stem from mass production.

For a low flow velocity it is often not the low pressure which is the power-limiting factor, but the poorly discharging medium downstream of the engine, which is the hindering factor. By means of a web in the engine housing 76 or/and a sheet piling this situation can be counteracted. Due to the elongated design of the piston, the size of the gap can be adapted to the dimensions of the feed aperture and an adequately large outlet duct 79 may be formed as well.

1. Method for generating mechanical energy from heat, solar energy or flow, characterized in that an engine (5) having a Wankel geometry and an elongated rotary piston (84) is driven as an expansion machine, instead of an explosion engine, with simultaneous impingement of a plurality of piston areas by a force, pressure or reduced pressure so that the actuation takes place even at a low pressure or temperature gradient.

2. Method according to claim 1, characterized in that during an evaporation process the heat transfer takes place by mixing different materials, in particular liquids, which may, advantageously, be changed according to the temperature range.

3. Method according to claim 1, characterized in that the fluid flowing from the engine or from a turbine is sucked into a cooled liquid in a condenser, wherein a reduced pressure is created mechanically or by volume reduction through cooling and condensation of the fluid.

4. Method according to claim 1, characterized in that in the case of a gas which in liquefied form has a higher density than the coolant liquid (24), so much hot gas is sucked in that the latter accumulates in a multitude of bubble caps (25), closed towards the top, distributing the gas uniformly in the form of small units in a tank (38) and preventing it from further rising and renewed flowing together, in order to subsequently liquefy it by mechanical, pneumatic or hydraulic increase of pressure, whereupon the liquid settles and can be withdrawn in the lower portion (29) of the tank.

5. Method according to claim 1 for utilization in solar plants, characterized in that the hot water or a heat transfer liquid flows into flat collectors as well as into interconnected, continuous vacuum tubes (53), that these vacuum tubes are advantageously mounted in spaced-apart relationship to one another in order to allow light and rainwater to flow through, and which are either sealed in a vacuum-tight manner or wherein the vacuum is maintained by a pump (58).

6. Device for carrying out the method according to claim 1 in a cyclic process, comprising a vapor generator (4) and a condenser (7) for a working medium which can be evaporated, characterized in that the vapor generator (4) is supplied with heat from geothermal heat, industrial waste heat, solar collectors (1) or via a heat accumulator or from a hot water storage device and that the expansion machine (5) is interposed between this vapor generator (4) and the condenser (7), and can be driven by the working medium.

7. Device for carrying out the method according to claim 1 without a cyclic process, characterized in that an air or water flow is utilized as the driving medium for the engine (5) having the Wankel geometry.

8. Device according to claim 6 or 7, characterized in that the engine (5) has a geometry according to the Wankel engine principle with a ratio of transmission, gear wheel transmission of 1:2, 2:3, 3:4 etc. Or x:x+1 of the gearwheel (10) to the inner gear rim (11).

9. Device according to claim 8, characterized in that the piston of the engine (5) is designed in the form of an elongate drum (35), that a pivoting axle passes through the said drum and is mounted and supported at both ends and that the rotary piston is housed, at least in part, in a housing.

10. Device according to claim 8, characterized in that the piston (84) of the engine comprises a cylindrical jacket, that transverse partitions, webs (85) as well as form-fit profile are present inside the said cylinder, preferably made of sheet metal, and that a shaft is provided.

11. Device according to claim 6, characterized in that valves are provided which are intended for controlling the gas flow towards and/or away from the engine (5), that the body of the valve is designed as a rotary tube or as a roll (18), that the said tube is pivotally mounted in a housing, wherein inlet and outlet ducts are provided, that apertures (19) are provided in the valve body, which may be brought into alignment with the inlet and outlet ducts and that the driving mechanism of the valve body is coupled to the piston of the engine.

12. Device according to claim 6 or 7, characterized in that the volume flow impinges the piston without valve control arrangement through a first aperture in the housing and that the volume flow after its expansion exits from the expansion chamber through a further aperture, which is advantageously larger than the inflow aperture.

13. Device according to claim 6, characterized in that the housing is thermally insulated from the engine in the hot region, that the gas can be cooled from the outlet region up to the cooler, namely with the aid of highly heat-conducting tubes, cooling fins, a coolant liquid or an air flow.

14. Device according to claim 6, characterized in that water with its very high specific thermal capacity serves as an energy storage means, either for the hot or the cold region, and that a tank (3) is provided, wherein water may be stored for that purpose.
